(19) United States
(12) Patent Application Publication
(10) Pub. No.: US 2010/0218747 A1
(43) Pub. Date: Sep. 2, 2010

(54) Fuel Pump for Delivering Fuel from a Reservoir to an Internal Combusion Engine

(76) Inventor: Johannes Deichmann, Alheim-Sterkelshausen (DE)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/680,690

(22) PCT Filed: Sep. 24, 2008
(86) PCT No.: PCT/EP08/62719

§ 371 Date: Mar. 29, 2010

(30) Foreign Application Priority Data
Sep. 27, 2007 (DE) 10 207 046 580.9

(51) Int. Cl. F02M 37/04

(52) U.S. Cl. 123/497

(57) ABSTRACT

A fuel pump for delivering fuel from a reservoir to an internal combustion engine. The pump includes a casing, at least one impeller arranged in the casing. The impeller including at least one ring of interspaced vanes. The pump further includes an electric motor that drives the impeller via a shaft and that is configured as an axial field motor and that has a rotor and a stator. The rotor of said electric motor has permanent magnets and the coil formers carrying windings that are opposite the permanent magnets are stationarily arranged in the stator at a distance to the rotor axis and at even angular distances. The coil formers are arranged in parallel to the shaft of the electric motor with respect to their longitudinal orientation.

### PRIORITY CLAIM

This is a U.S. national stage of application No. PCT/EP2008/062719, filed on 24 Sep. 2008, which claims priority to the German Application No. 10 2007 046 580.9, filed: 27 Sep. 2007, the content of both incorporated herein by reference.

### BACKGROUND OF THE INVENTION

1. Field of the Invention

The invention relates to a fuel pump for delivering fuel from a reservoir to an internal combustion engine, having a casing and at least one impeller arranged in the casing. The impeller has at least one ring of vanes arranged spaced apart and an electric motor, which drives the impeller by a shaft. The motor is designed as an axial field motor with a rotor and a stator. The rotor has permanent magnets. Coil forms, which carry windings, are arranged in a fixed manner in the casing, opposite the permanent magnets, at a distance from the rotor axis and at uniform angular intervals.

2. Related Art

Constructing fuel pumps with an electric motor and an impeller is a well known practice, the electric motor axially adjoining the impeller, which revolves in a pump chamber. The electric motor comprises a rotor, which carries the windings and is surrounded by a stator which has the permanent magnets. The pump chamber and the drive motor are surrounded by a common casing. During the operation of the fuel pump, the fuel is pumped through the pump chamber and the electric motor. The disadvantage in this type of pump is the fact that the fuel flows through the electric motor since the rotor leads to turbulence in the fuel delivered and hence to power losses. Moreover, the construction of fuel pumps of this kind have a certain overall length and they are subject to limits in terms of their arrangement in fuel tanks because fuel tanks are becoming increasingly flatter.

A fuel pump with a short overall length is known from DE 196 17 495 A1. In this fuel pump, the rotor of the electric motor and the impeller of the pump form a one-piece constructional unit. The rotor, which is situated radially on the inside, carries the windings in this arrangement. The impeller adjoins the rotor radially on the outside. Permanent magnets are arranged on both sides of the rotor opposite the windings on the rotor, and these permanent magnets form the stator of the electric motor. Adjoining the permanent magnets radially on the outside is the pump casing, which accommodates the impeller with the vane rings. The disadvantage with this design of an axial field motor is the large diameter of the rotor due to the size of the windings, which are in turn required to achieve a given torque of the electric motor. Particularly where the fuel pump is used in a reservoir, it is not possible to arbitrarily increase the diameter of the fuel pump due to the predetermined openings in the reservoir.

### SUMMARY OF THE INVENTION

It is therefore an underlying object of the invention to provide a fuel pump of improved efficiency and small dimensions.

According to one embodiment of the invention, coil forms are arranged parallel to the shaft of the electric motor with respect to their longitudinal alignment.

Providing the coil forms in the stator makes possible an axially aligned arrangement of the coil forms. As a result, it is possible to make the diameter of the coil arrangement significantly smaller than where the coils are arranged on the rotor. A fuel pump constructed in this way has a significantly smaller outside diameter, approximately in the range of fuel pumps used hitherto. The fuel pump according to the invention can thus be used in existing delivery units.

The arrangement of the coil forms involves a particularly low outlay if the stator has radially extending walls, with chambers being formed by the walls, and at least one coil form carrying the windings is arranged in one chamber. In this arrangement, the stator forms part of the casing.

Turbulence in the region of the permanent magnets is avoided in one embodiment if the permanent magnets are arranged in the rotor such that they end at respective side face of the rotor.

In one embodiment, the rotor comprises a rotor disk on which the permanent magnets are arranged.

In one embodiment output of the fuel pump can be increased if the rotor comprises two rotor disks arranged on both sides of the coil arrangement in the axial direction, thus enclosing the coil arrangement.

In another embodiment, the impeller is arranged upstream of the rotor. This has the advantage that the electric motor can be preassembled and tested as a subassembly before being installed in the fuel pump. If the fuel pump has a preliminary pump stage and a main pump stage, an advantageous refinement consists in that two impellers are provided, with the electric motor being arranged between the impellers.

The fuel pump according to one embodiment of the invention requires a particularly small amount of installation space in the axial direction if the impeller forms a constructional unit with the rotor.

With respect to the permanent magnets, the impeller can be arranged radially on the inside or radially on the outside. If the impeller is arranged in the radially outer region of a rotor disk, an impeller of annular design has proven advantageous. In this case, the impeller can be designed either as a side channel or peripheral impeller while, in the case of arrangement radially on the inside of the permanent magnets, it is designed as a side channel impeller.

However, it is also conceivable to design the rotor as a rotor disk which is designed as an impeller of a peripheral or side channel pump in its radially outer region, and to arrange a further pump impeller upstream of the rotor disk.

In one embodiment, the arrangement of a separate pump impeller is avoided by the fact that the rotor has two rotor disks, which are arranged on both sides of the coil arrangement in the axial direction, the impellers being of annular design and each being arranged in the radially outer region of a rotor disk, the rotor disks and the impellers thus forming a constructional unit.

Providing a plurality of pump stages makes it possible to increase the delivery rate of the fuel pump compared with a design that has just one pump stage. As already described, the pump stage can be designed as a separate impeller or as a constructional unit with a rotor. The provision of a plurality of pump stages can be used not only to increase the delivery rate but also to supply a plurality of consuming units or for the purpose of filling a reservoir, in particular an anti-surge pot.

In the fuel pump according to one embodiment of the invention, one pump stage is used to deliver fuel to the internal combustion engine of the motor vehicle, while the other pump stage delivers fuel to drive an ejector pump.

Since the fuel requirement of an ejector pump is significantly less than that of an internal combustion engine, it is advantageous, according to a further refinement, in the case of a plurality of pump stages for only part of the quantity of fuel delivered by a pump stage to be fed to the ejector pump, while the remaining quantity of fuel is delivered to the internal combustion engine.

It is helpful for cooling the electric motor if the stator is designed in such a way that the fuel delivered by an impeller situated upstream of the coil arrangement flows through the coil arrangement.

Feeding the fuel to the coil arrangement involves little outlay if the outlet of the impeller, which is situated upstream of the coil arrangement, and the coil arrangement are connected to a channel. The channel can follow an oblique or angled path in relation to the shaft of the electric motor. A channel path of this kind can be simply produced.

Due to the fact that some constituents of the fuel are aggressive, protective measures for parts of the electric motor are often necessary. Such measures can be avoided with a stator designed in such a way that the fuel delivered by an impeller situated upstream of the coil arrangement flows around the stator that forms the casing and has the coil arrangement. In this way, the coil arrangement is not cooled directly by the fuel but by way of the heat transfer to the stator. Cooling can be intensified with a stator made from a material of good thermal conductivity.

Such fuel routing in the fuel pump can be achieved with a fuel channel arranged in the stator, the channel being arranged parallel to the coil arrangement in the region of the coil arrangement.

In contrast, a distributing device arranged downstream of the outlet of the impeller makes it possible to divide the fuel flow delivered, allowing part of the flow to be guided through the coil arrangement and part of the flow to be guided past the coil arrangement.

A distributing device of this kind can also be used to divide the fuel flow so that part is directed to a first consuming unit, in particular an ejector pump, and the remaining part is directed to a second consuming unit, in particular a second pump stage or the internal combustion engine.

### BRIEF DESCRIPTION OF DRAWINGS

The invention is explained in greater detail by a number of illustrative embodiments. In the drawings:

FIG. 1 is an exploded representation of a fuel pump with two impellers;

FIGS. 2a-c show further embodiments of a fuel pump with separate impellers;

FIGS. 3a-d show further embodiments of a fuel pump with integrated impellers; and

FIGS. 4a-c show further embodiments of a fuel pump with a plurality of coil arrangements.

### DETAILED DESCRIPTION OF THE DRAWINGS

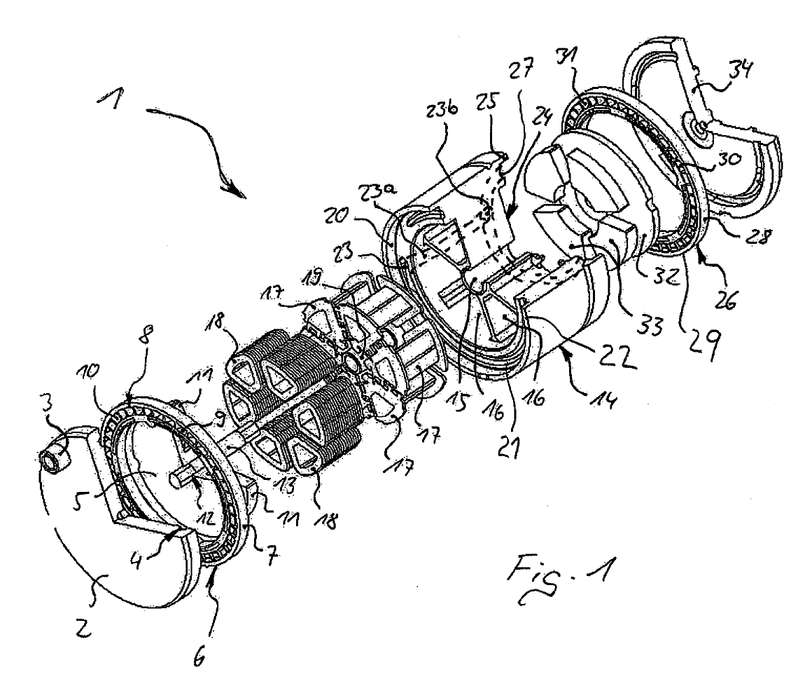

Fuel pump 1 illustrated in FIG. 1 comprises a first casing cover 2, which has an inlet stub 3 via which fuel is drawn in by the fuel pump 1. On the side facing away from the inlet stub 3, the first casing cover 2 has an annular channel 4 of semicircular cross section, which is connected to the inlet stub 3 and preferably extends over 330°.

Arranged opposite the channel 4 there is a first rotor 5. The first rotor 5 has a ring 7, which forms a first impeller 6 on both sides of which are arranged respective rings 8 of vanes 10 delimiting vane chambers 9.

Four magnets 11 in the form of a circular ring are connected to the first rotor 5 on a side facing away from the first casing cover 2. The first rotor 5 has a central bore 12, in which a shaft 13 is arranged in a torsionally rigid manner.

Adjoining the first rotor 5 is a stator 14. The stator 14 has a central bore 15. A bearing bush 19 for the shaft 13 is inserted into the bore 15. Arranged concentrically around the bore 15 are six chambers 16 at uniform angular intervals relative to one another, in each of which a coil form 17 is arranged. The chambers 16 are separated from one another along their axial extent by chamber walls. The coil forms 17 are aligned in such a way as to be arranged parallel to the shaft 13 of the electric motor in terms of their longitudinal extent. A winding 18 is arranged on each of the coil forms 17. The coil forms 17 with the windings 18 are arranged concentrically in such a way that they lie opposite the magnets 11 of the first rotor 5.

On its side 22 facing the first rotor 5, in its radially outer region, the stator 14 has a shoulder 20, which is designed in such a way that the ring 7, forming the first impeller 6, is accommodated therein. The shoulder 20 has a channel 21 in the form of a partial ring that corresponds in arrangement and design to the channel 4 in the first casing cover 2, with the result that the first casing cover 2, the ring 7 and the shoulder 20 form a side channel pump stage.

At its end in the direction of delivery, the channel 21 in the form of a partial ring in the stator 14 has an outlet 23, which extends as a channel 23a in the radially outer region of the stator 14 as far as an inlet 23b. Opposite the side 22, the stator 14 has a side 24 of identical construction with a shoulder 25 for accommodating a second impeller 26 and a channel 27 in the form of a partial ring. The channel 27 in the form of a partial ring begins at the inlet (not shown) and likewise preferably extends over an angular range of 330°.

The second impeller 26, which is formed by a ring 28, corresponds in construction to the impeller 6 with rings 29, arranged on both sides of vanes 31 delimiting vane chambers 30. The second impeller 26 forms a constructional unit with a second rotor 32. The second rotor 32 with the magnets 33 corresponds in terms of construction and arrangement with respect to the coil forms 17 with the windings 18 to the first rotor 5. On the side of the second rotor 32 which faces away from the magnets 33, the fuel pump 1 is closed off by a second casing cover 34, which corresponds in construction to the first casing cover 2. Owing to its compact construction, the fuel pump 1 has an axial length of about 35 mm and a diameter of about 70 mm.

During the operation of the fuel pump 1, fuel is drawn in via the inlet 3. The fuel drawn in flows into the channel 4 in the form of a partial ring and is delivered to the outlet 23 by the first impeller 6. The fuel then flows in the stator as far as the inlet (not shown), which opens into the channel 24 in the form of a partial ring of the second side channel pump stage with the second impeller 26. After the fuel has been pumped along the channel 24 in the form of a partial ring by the second impeller 26, the fuel emerges at the nominal pressure from the outlet (not shown) in the second casing cover 34. From there, the fuel is delivered to a consuming unit, e.g. an internal combustion engine (not shown). Rotation of the impellers 6, 26 is brought about through the connection to the two rotors 5, 32, which are, in turn, connected to one another by the common shaft 13.

The figures which follow show further embodiments in accordance with the fuel pump in FIG. 1 as regards the number and arrangement of the significant subassemblies, in section. To better illustrate the different arrangements, only the subassemblies comprising the rotor with the magnet, the impeller, the shaft and the coil formers with the winding are shown, the subassemblies being shown in schematic form to simplify illustration. The fuel pump delivers the fuel from left to right.

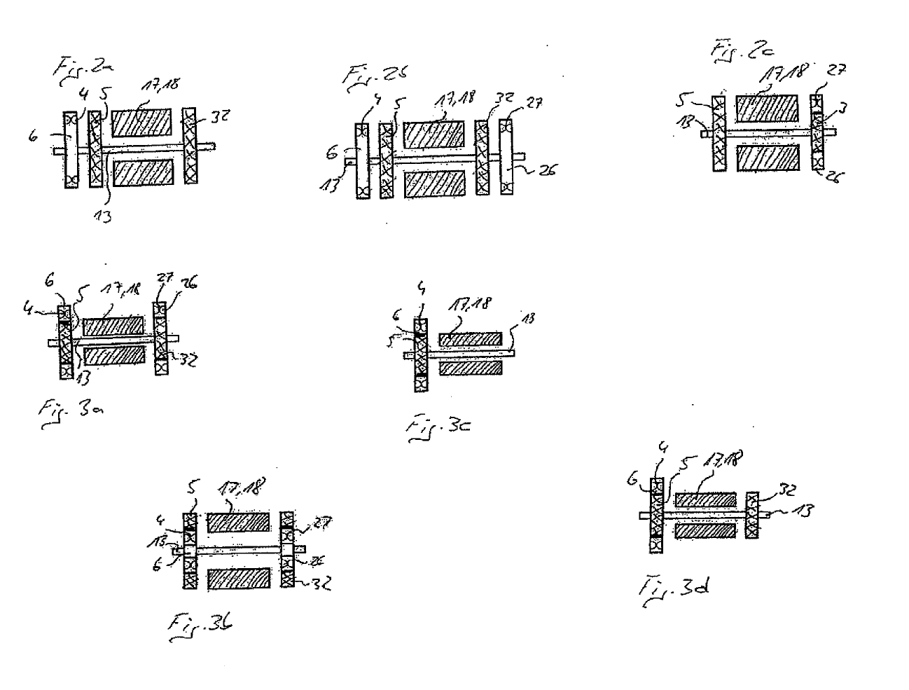

In FIG. 2a, a separate impeller 6 is arranged on the shaft 13. A first rotor 5 and a second rotor 32 are arranged downstream of rotors. The coil forms 17 with winding 18 are arranged between the two rotors 5, 32. The impeller 6 and the rotor 5 are separate components.

The construction of the fuel pump 1 in FIG. 2b corresponds to the construction according to FIG. 2a. The only difference is that a second impeller 26 is arranged as an additional component downstream of the second rotor 32. The internal combustion engine is supplied with fuel by the second impeller 32, which is a second pump stage. The fuel delivered by the first impeller 6 preferably drive an ejector pump (not shown).

FIG. 2c shows a fuel pump 1 with just one rotor 5, which is followed in the direction of flow by coil forms 17 with winding 18. An impeller 26 is arranged on the side of the coil forms 17 which faces away from the rotor 5. Due to the simplicity of its construction, a fuel pump 1 of this kind requires a small amount of installation space and, with the single impeller 6, is suitable for less demanding requirements.

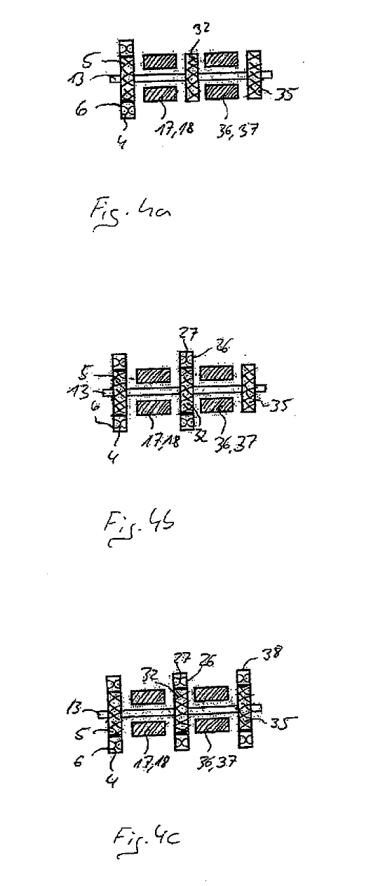

Having described fuel pumps with separate impellers, fuel pumps with impellers which form a constructional unit with a rotor will be described below. FIG. 3a shows a fuel pump 1 of this kind in schematic form. In terms of its construction, the fuel pump 1 corresponds to the pump in FIG. 1.

FIG. 3b shows a fuel pump 1 which differs from the fuel pump according to FIG. 3a in that the impellers 6, 26 are arranged radially on the inside in relation to the rotors 5, 32.

FIG. 3c shows a fuel pump 1 with just one rotor 5 and one impeller 6. This fuel pump 1 is distinguished by the smaller amount of space it requires.

The fuel pump 1 in FIG. 3d has two rotors 5, 32 and one impeller 6, the impeller 6 forming a constructional unit with the first rotor 5.

Fuel pumps for more demanding requirements are shown in FIGS. 4a-c. The fuel pump 1 in FIG. 4a has three rotors 5, 32, 35, between which coil forms 17, 36 with windings 18, 37 are arranged, the coil forms 17, 36 being aligned parallel to the rotor axis in terms of their longitudinal alignment.

In FIG. 4a, the fuel pump 1 has an impeller 6 which forms a constructional unit with the first rotor 5. According to FIG. 1, the impeller 6 is arranged radially on the outside as a ring on the first rotor 5.

The fuel pump 1 in FIG. 4b has two impellers 6, 26 in accordance with the impellers in FIG. 1. Both impellers 6, 26 deliver fuel to the internal combustion engine (not shown). Moreover, part of the fuel delivered by the first impeller 6 is fed to an ejector pump (not shown) in order to drive the latter.

The fuel pump 1 in FIG. 4c is based on the fuel pump 1 in accordance with FIG. 4b, except that the third rotor 35 likewise forms a constructional unit with an impeller 38 in a manner similar to rotors 5, 32.

The invention is not restricted to impellers with a ring of vanes delimiting vane chambers on each side of the impeller and the corresponding channels in the form of partial rings in the casing cover and the stator. It is also possible for the impellers with the corresponding channels to have a plurality of concentrically arranged rings of vanes delimiting vane chambers or a plurality of, preferably two, corresponding channels arranged on a pitch circle diameter. It is likewise possible for the at least one ring of vanes delimiting vane chambers to be arranged on just one side of an impeller.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-15. (canceled)

16. A fuel pump for delivering fuel from a reservoir to an internal combustion engine, comprising:
a casing;
at least one impeller arranged in the casing having at least one ring of spaced apart vanes;
a shaft; and
an axial field electric motor configured to drive the impeller by the shaft comprising:
a rotor having a plurality of permanent magnets;
a stator; and
coil forms that carry windings arranged parallel to the shaft of the electric motor with respect to their longitudinal alignment in a fixed manner in the stator opposite the plural permanent magnets at a distance from the rotor axis and at uniform angular intervals.

17. The fuel pump as claimed in claim 16, wherein the stator comprises:
radially extending walls with a plurality of chambers being formed by the walls and at least one coil form carrying the windings is arranged in one of the plural chambers.

18. The fuel pump as claimed in claim 16, wherein the plural permanent magnets are arranged in the rotor such that respective sides of the plural magnets end at a side face of the rotor.

19. The fuel pump as claimed in claim 16, wherein the rotor comprises a rotor disk.

20. The fuel pump as claimed in claim 16, wherein the rotor comprises at least two rotor disks.

21. The fuel pump as claimed in claim 18, wherein two rotor disks are arranged on both sides of the coil forms in the axial direction.

22. The fuel pump as claimed in claim 16, wherein the at least one impeller is arranged upstream of the rotor.

23. The fuel pump as claimed in claim 19, wherein the at least one impeller is configured as a constructional unit with the rotor disk.

24. The fuel pump as claimed in claim 23, wherein the at least one impeller is arranged radially on the outside of the one rotor disk.

25. The fuel pump as claimed in claim 16, further comprising a first and a second impeller, wherein the electric motor is arranged between the first and the second impellers.

26. The fuel pump as claimed in claim 16, wherein the stator is configured such that the fuel delivered by the at least one impeller situated upstream of the coil forms flows through the coil arrangement.

27. The fuel pump as claimed in claim 24, further comprising an impeller outlet arranged upstream of the coil forms, wherein and the coil arrangement is connected to a channel that follows one of an oblique path and an angled path in relation to the shaft.

28. The fuel pump as claimed in claim 16, wherein the stator is configured such that the fuel delivered by the at least one impeller situated upstream of the coil arrangement flows past the coil arrangement.

29. The fuel pump as claimed in claim 16, wherein a fuel channel extending parallel to the coil arrangement is arranged in the region of the coil arrangement.

30. The fuel pump as claimed in claim 16, further comprising a distributing device arranged downstream of the outlet of the impeller configured to guide a first part of the fuel through the coil arrangement and a second part of the fuel can be guided past the coil arrangement.
